(19) United States
(12) Patent Application Publication
(10) Pub. No.: US 2004/0246319 A1
(43) Pub. Date: Dec. 9, 2004

(54) WHITE INKJET INK AND INKJET RECORDING METHOD

(76) Inventors: Akio Ito, Kanuma-shi (JP); Yukiko Murasawa, Kanuma-shi (JP); Hideaki Takashi, Kanuma-shi (JP)

Correspondence Address: OLIFF & BERRIDGE, PLC, P.O. BOX 19928, ALEXANDRIA, VA, 22320, US

(21) Appl. No.: 10/489,094

(22) PCT Filed: Oct. 2, 2002
(86) PCT No.: PCT/JP02/10268

(30) Foreign Application Priority Data
Oct. 4, 2001 (JP) 2001-309004

(51) Int. Cl. G01D 11/00

(52) U.S. Cl. 347/100

(57) ABSTRACT

A white inkjet ink is formed from a photoreactive polyfunctional monomer, a white pigment, and a photopolymerization initiator, and the viscosity at 40° C. is adjusted to 13 mPa·s or less. An α-hydroxyketone compound or benzyl dimethyl ketal compound is preferably used as the photopolymerization initiator.

### TECHNICAL FIELD

This invention relates to a white ink used in inkjet printers.

### BACKGROUND ART

Up to now, the printing of multicolored labels in the manufacture of CDs and DVDs has been accomplished by screen printing or offset printing, which means that offline manufacture is necessary, and this method is also costly in terms of platemaking whenever a design is changed. In view of this, there is a need to be able to print by inkjet method so that the printing of multicolor labels in the manufacture of CDs and DVDs can be performed inline and to make the manufacturing line more flexible for small-lot production.

In this case, the first inkjet ink that is required is a white ink that is used to coat the base layer.

This white ink needs to have low enough viscosity that it can be discharged from an inkjet nozzle, to allow high-speed printing, to have excellent durability in printed form, and to be usable on existing production lines, and there have been studies into the possibility that a UV-curing ink may satisfy these requirements.

Also, the white ink used to form the undercoat layer needs to have good white hiding power in printed form. One possible way to increase the white hiding power of print is to add a white pigment such as titanium oxide to the ink. It is also possible to use a photoreactive monomer such as a UV-curing acrylate as a dispersion medium for the white pigment (see Japanese Laid-Open Patent Application No. H9-183929).

However, a problem with a white ink in which titanium oxide is dispersed in a photoreactive monomer is that since titanium oxide reflects UV rays, the ink coating film is slow to cure, and furthermore the film strength of the ink coating after curing is low. This tendency is particularly pronounced when a monofunctional photoreactive monomer is used.

To deal with this, it is possible to use a polyfunctional photoreactive monomer so that the ink coating film will cure faster.

However, when a trifunctional or tetrafunctional photoreactive monomer is used in a large quantity, the viscosity of the ink itself increases, the ink clogs the nozzle of the inkjet printer head, and this leads to poor discharge. One way to solve this problem of increased ink viscosity is to add a solvent such as toluene, methyl ethyl ketone, or isopropyl alcohol to the ink to lower its viscosity, but the use of these solvents is undesirable as it can be harmful to humans.

Another problem encountered with a white ink in which titanium oxide is dispersed in a photoreactive monomer is that with some types of photopolymerization initiator, the cured ink film may yellow, so that a white coating film is not obtained.

In view of this, it is an object of the present invention to provide a white inkjet ink in which titanium oxide or another such white pigment is dispersed in a photoreactive monomer, whose viscosity is low enough that the ink does not clog the nozzle of an inkjet printer, and with which a coating film of this white ink cures well, and the cured ink film is white and exhibits no yellowing.

### DISCLOSURE OF THE INVENTION

The inventors have discovered that by adjusting the blend ratio of various photoreactive polyfunctional monomers, the blend amount of photoreactive polyfunctional monomer, the blend amount of white pigment, and other such variables, the viscosity of a white ink at 40° C. can be lowered to 13 mPa·s or less, and when this ink is used for printing with an inkjet printer, if the ink is preheated before being discharged from the nozzle, so that its viscosity during discharge is 13 mpa·s or less, ink discharge problems can be prevented, the ink coating film will cure rapidly under UV irradiation, and the film strength will be high, and furthermore, if a specific photopolymerization initiator is used, yellowing of the cured ink coating film will be prevented and a white film will be obtained.

Specifically, the present invention provides a white inkjet ink composed of a photoreactive polyfunctional monomer, a white pigment, and a photopolymerization initiator, wherein the viscosity at 40° C. is 13 mPa·s or less.

More particularly, it provides an aspect wherein an α-hydroxyketone compound or a benzyl dimethyl ketal compound is used as the photopolymerization initiator.

The present invention also provides an inkjet recording method, wherein the above-mentioned white ink is heated so that its viscosity is 13 mpa·s or less, and printed onto a recording medium by inkjet method.

### BEST MODE FOR CARRYING OUT THE INVENTION

The present invention will now be described in detail.

The white inkjet ink of the present invention contains a photoreactive polyfunctional monomer, a white pigment, and a photopolymerization initiator, and its viscosity at 40° C. is 13 mPa·s or less.

Examples of the photoreactive polyfunctional monomer include difunctional acrylate monomers such as 1,3-butanediol diacrylate, 1,4-butanediol diacrylate, nonanediol diacrylate, diethylene glycol diacrylate, diethylene glycol dimethacrylate, and tripropylene glycol diacrylate; trifunctional acrylate monomers such as ethoxylated trimethylolpropane triacrylate and trimethylolpropane triacrylate; and tetrafunctional acrylate monomers such as ethoxylated pentaerythritol tetraacrylate.

These can be used singly or in combinations of two or more types, but using a difunctional acrylate monomer or a trifunctional acrylate monomer, and especially using both, is preferable because it will be possible to satisfy both the need for good ink discharge from the head of an inkjet printer and the need for fast curing of the ink coating film under UV irradiation. In this case, the total amount of difunctional acrylate monomer and trifunctional acrylate monomer added is preferably 50 to 90 wt % of the ink, and it is particularly favorable to adjust the weight ratio of the difunctional acrylate monomer and trifunctional acrylate monomer to between 9/1 and 1/9.

The white pigment can be titanium oxide, zinc oxide, barium sulfate, clay, or another such inorganic pigment, or a resin filler based on acrylic, styrene, melamine, or the like. This white pigment is preferably one having an average particle size of 5 μm or less.

From the standpoints of ink discharge from the head of an inkjet printer and the white hiding power of the ink coating film, the amount of the white pigment is contained in the ink in an amount of preferably 1 to 30 wt %.

There are two types of photopolymerization initiator: one that promotes a photopolymerization reaction when used together with an amine-based promoter such as p-dimethylaminobenzoate ethyl ester or isoamyl p-dimethylaminobenzoate ester (P2 type), and the other that promotes a photopolymerization reaction through self-cleavage without the use of a promoter (P1 type). P1 type photopolymerization initiators are preferred because no yellowing of the ink coating film is caused by a promoter, and in terms of preventing the yellowing of the ink coating film and obtaining a white film, it is particularly favorable to use an α-hydroxyketone compound such as 1-hydroxy-cyclohexyl-phenyl ketone, or a benzyl dimethyl ketal compound such as 2-hydroxy-2-methyl-1-phenyl-propan-1-one.

Curability will be poor if the photopolymerization initiator is contained in too small an amount in the ink, but on the other hand dispersibility of the white pigment and ink storage and discharge stability will decrease if the amount is too large, so the amount is preferably from 5 to 10 weight parts per 100 weight parts of ink excluding the photopolymerization initiator.

The white inkjet ink of the present invention can be prepared by mixing the above-mentioned photoreactive polyfunctional monomer, white pigment, and photopolymerization initiator, but in order for the ink to be discharged properly from the nozzle of an inkjet printer without clogging, the various components are adjusted to within the blend ratios given above so that the viscosity of the ink at 40° C. will be 13 mPa·s or less, and preferably 1.0 to 11.5 mPa·s. The purpose of thus specifying the viscosity at 40° C. is to strike a good balance between improving the discharge reliability of an ink containing a high-viscosity monomer in order to improve curability, and maintaining the durability of the ink head.

The ink viscosity in the present invention refers to the numerical value obtained using a vibro-viscometer at 40° C. The white inkjet ink of the present invention can also contain as needed a surfactant, polymer, or other dispersant, an antifoaming agent, a wax, an antioxidant, a light stabilizer, an antistatic agent, or the like.

With the inkjet recording method of the present invention, a printed image composed of an ink coating film is formed on a CD or any other printing medium by using an inkjet printer with which the above-mentioned white inkjet ink of the present invention is discharged. In this case the ink and the ink head are heated so that the viscosity of the ink at least during its discharge will be no more than 13 mPa·s, and preferably 1.0 to 11.5 mPa·s.

This heating of the ink can be accomplished, for example, by heating the inkjet printer or the environment in which the inkjet printer is installed.

The ink coating film formed on the printing medium with an inkjet printer is cured by UV irradiation, and the UV irradiation conditions in this case preferably include the use of a metal halide lamp at 100 to 2400 mj/cm².

The ink coating film is preferably formed so that its thickness is between 1 and 20 μm. In terms of hiding power, curability, and so forth, it is particularly favorable for the ink coating film to be from 5 to 10 μm thick.

### EXAMPLES

### Test Example 1

In order to examine the relationship between ink discharge and the blend ratio of monofunctional to tetrafunctional acrylate monomer, first monofunctional to tetrafunctional acrylate monomers were added in the proportions shown in Table 1 to obtain six types of acrylate monomer M-1 to M-6, and the viscosity of these monomers was measured with a vibro-viscometer (CJV5000 made by A & D).

TABLE 1

| | Acrylate monomer blend ratio | | | | |
|---|---|---|---|---|---|
| Blend | Mono- | Di- | Tri- | Tetra- | Viscosity |
| No. | functional | functional | functional | functional | (mPa · s/25° C.) |
| M-1 | 10 (*1) | | | | 4 |
| M-2 | | 10 (*2) | | | 7 |
| M-3 | | 5 (*2) | 5 (*3) | | 13.8 |
| M-4 | | 7 (*2) | 3 (*4) | | 18.3 |
| M-5 | | 7 (*2) | | 3 (*5) | 21.8 |
| M-6 | | 5 (*2) | | 5 (*5) | 33.7 |

(*1) tetrahydrofurfuryl acrylate (V #150 made by Osaka Organic Chemical Industry)
(*2) 1,3-butanediol diacrylate (SR212B made by Sartomer)
(*3) ethoxylated trimethylolpropane triacrylate (SR454 made by Sartomer)
(*4) trimethylolpropane triacrylate (A-TMPT made by Shin Nakamura Chemicals)
(*5) ethoxylated pentaerythritol tetraacrylate (Sr494 made by Sartomer)

Next, as shown in Table 2 or 3, the six types of acrylate monomer M-1 to M-6 were each blended with either 10, 20, or 30 wt % of titanium oxide and with 3 wt % of dispersant (Solsperse 26000 made by Zinneke), where the titanium oxide had been surface treated with aluminum and silicon (CR80 made by Ishihara Sangyo). This blend was dispersed ultrasonically for 1 hour to prepare 18 types of ink (containing no photopolymerization initiator), and the viscosity of each at 25° C. and 40° C. was measured in the same way as above.

An A4 solid printing test was then conducted with a printer (equivalent to 300 dpi) having a piezo-type original head and using these inks, and the ink discharge performance was rated as follows.

A: good discharge

B: discharge possible for a time

C: discharge impossible

These results are given in Tables 2 and 3.

TABLE 2

| | | Titanium oxide concentration | | |
|---|---|---|---|---|
| Ink | Acrylate | 10 wt % | 20 wt % | 30 wt % |
| No. | monomer | Viscosity [mPa · s] at 25° C./discharge performance | | |
| 1-1-1 | M-1 | 4.7/A | | |
| 1-1-2 | M-1 | | 5.78/A | |
| 1-1-3 | M-1 | | | 7.87/A |
| 1-2-1 | M-2 | 9.6/A | | |
| 1-2-2 | M-2 | | 13.0/A | |
| 1-2-3 | M-2 | | | 16.7/B |
| 1-3-1 | M-3 | 17.8/B | | |
| 1-3-2 | M-3 | | 22.8/B | |
| 1-3-3 | M-3 | | | 28.9/C |
| 1-4-1 | M-4 | 21.4/B | | |
| 1-4-2 | M-4 | | 29.0/C | |
| 1-4-3 | M-4 | | | 40.4/C |
| 1-5-1 | M-5 | 27.1/B | | |
| 1-5-2 | M-5 | | 36.6/C | |
| 1-5-3 | M-5 | | | 48.7/C |
| 1-6-1 | M-6 | 40.7/C | | |
| 1-6-2 | M-6 | | 53.1/C | |
| 1-6-3 | M-6 | | | 77.6/C |

TABLE 3

| | | Titanium oxide concentration | | |
|---|---|---|---|---|
| Ink | Acrylate | 10 wt % | 20 wt % | 30 wt % |
| No. | monomer | Viscosity [mPa · s] at 40° C./discharge performance | | |
| 1-1-1 | M-1 | — | | |
| 1-1-2 | M-1 | | 4.87/A | |
| 1-1-3 | M-1 | | | 6.23/A |
| 1-2-1 | M-2 | — | | |
| 1-2-2 | M-2 | | 9.12/A | |
| 1-2-3 | M-2 | | | 11.3/A |
| 1-3-1 | M-3 | 11.5/A | | |
| 1-3-2 | M-3 | | 14.6/B | |
| 1-3-3 | M-3 | | | 17.9/B |
| 1-4-1 | M-4 | 14.1/B | | |
| 1-4-2 | M-4 | | 17.7/B | |
| 1-4-3 | M-4 | | | 24.1/B |
| 1-5-1 | M-5 | 16.8/B | | |
| 1-5-2 | M-5 | | 21.5/B | |
| 1-5-3 | M-5 | | | 27.3/C |
| 1-6-1 | M-6 | 24.1/B | | |
| 1-6-2 | M-6 | | 30.0/C | |
| 1-6-3 | M-6 | | | 41.7/C |

It can be seen from Tables 2 and 3 that discharge from the inkjet printer was possible when the ink viscosity was around 25 mPa·s or lower, and when it was 13 mPa·s or lower, the discharge continued stably. Further, even when the discharge performance at 25° C. was rated as B, the discharge performance was sometimes rated as A at 40° C. (inks 1-2-3 and 1-3-1), which tells us that when an ink is used in a heated state with an inkjet printer, the discharge performance should be evaluated at the temperature of this heated state.

It can also be seen that the greater the number of functional groups of the acrylate monomer, the worse is the discharge performance, and that it is difficult to obtain good discharge at 40° C. when a tetrafunctional acrylate monomer and a difunctional acrylate monomer are used together in a ratio of 5:5 (M-6), but good discharge is obtained at 40° C. when a trifunctional acrylate monomer and a difunctional acrylate monomer are used together in a ratio of 5:5 (M-3).

### Test Example 2

In order to examine the relationship between hiding power and the titanium oxide concentration in the ink, 10 types of ink were prepared by adding titanium oxide in the various concentrations shown in Table 4 to the same acrylate monomer blend as in M-3, and transparent PET films were coated such that the respective ink thickness after curing would be 5, 10 or 20 μm. The hiding power of each ink coating film was rated as follows by laying the PEF film on which the ink coating film had been formed over a CD and observing the underlying CD.

A: the CD could not be seen through the film

B: the CD could be faintly seen through the film

C: the CD could be clearly seen through the film

The results are given in Table 4.

TABLE 4

| | Thickness of ink coating film | | |
|---|---|---|---|
| Titanium oxide | 5 μm | 10 μm | 20 μm |
| concentration (wt %) | Hiding power | | |
| 3 | C | C | B |
| 4 | C | C | A |
| 5 | C | C | A |
| 6 | C | B | A |
| 7 | C | A | — |
| 8 | B | A | — |
| 9 | A | A | — |
| 10 | A | A | — |
| 20 | A | — | — |
| 30 | A | — | — |

It can be seen from Table 4 that to obtain sufficient hiding power, the concentration of titanium oxide in the ink must be at least 8 wt % when the thickness of the ink coating film is 5 μm, must be at least 6 wt % when the thickness of the ink coating film is 10 μm, and must be at least 3 wt % when the thickness of the ink coating film is 20 μm.

### Test Example 3

In order to examine the relationship between the type of hotopholymerization initiator and the curability of the ink, a test liquid was prepared by mixing 63 wt % of difunctional acrylate monomer (1,3-butanediol diacrylate (SR212B made by Sartomer), 27 wt % of trifunctional acrylate monomer (trimethylolpropane triacrylate (A-TMPT made by Shin Nakamura Chemicals), and 10 wt % of titanium oxide (CR80 made by Ishihara Sangyo), the ink was prepared by adding a dispersant (Solsperse 26000 made by Zinneke) to 100 weight parts of this test liquid, and 11 types of curable ink were prepared by adding 5 weight parts of the photopolymerization initiator shown in Table 5 to 100 weight parts of this ink.

Coating films (10 μm thick) of each of the curable inks thus obtained were obtained using an original inkjet printer, and each ink coating film was optically irradiated with a metal halide lamp at 80 W and a cumulative quantity of light of 310 mj/cm².

After this optical irradiation, each ink coating film was soaked with acetone and rubbed 10 times with a cotton swab, and the curing state of the ink coating film was rated as follows from the state after this rubbing. The results are given in Table 5.

A: print did not come off

B: some of the print came off

C: uncured

TABLE 5

| | | | | Number of | | | | |
|---|---|---|---|---|---|---|---|---|
| | Kind of | | Color | irradiations | | | | |
| Ink | photopolymerization | | after | 1 | 2 | 3 | 4 | 5 |
| No. | initiator | Type | curing | Curing state | | | | |
| 2-1 | α-aminoketone (*a) | P1 | Faint | B | A | | | |
| | | | yellow | | | | | |
| 2-2 | α-aminoketone (*b) | P1 | Yellow | B | B | A | | |
| 2-3 | bisacylphosphine | P1 | White | B | B | B | B | B |
| | oxide (*c) | | | | | | | |
| 2-4 | α-hydroxyketone (*d) | P1 | White | B | B | B | B | B |
| 2-5 | α-hydroxyketone (*e) | P1 | White | B | B | B | B | B |
| 2-6 | benzyl dimethyl | P1 | White | B | B | B | B | B |
| | ketal (*f) | | | | | | | |
| 2-7 | benzophenone (*g) | P2 | White | C | C | C | C | C |
| 2-8 | benzophenone-based (*h) | P2 | very | C | B | A | | |
| | | | faint | | | | | |
| | | | yellow | | | | | |
| 2-9 | thioxanthone-based (*i) | P2 | yellow | C | C | B | A | |
| 2-10 | thioxanthone-based (*j) | P2 | yellow | C | C | B | A | |
| 2-11 | anthraquinone-based (*k) | P2 | orange | B | A | | | |

(*a) Irgacure 907 made by Ciba Specialty Chemicals
(*b) Irgacure 369 made by Ciba Specialty Chemicals
(*c) bis(2,4,6-trimethylbenzoyl)-phenylphosphine oxide: Irgacure 819 made by Ciba Specialty Chemicals
(*d) 1-hydroxy-cyclohexyl-phenyl-ketone: Irgacure 184 made by Ciba Specialty Chemicals
(*e) 2-hydroxy-2-methyl-1-phenyl-propan-1-one: Darocure 1173 made by Ciba Specialty Chemicals
(*f) 2,2-dimethoxy-1,2-diphenylmethan-1-one: Irgacure 651 made by Ciba Specialty Chemicals
(*g) benzophenone: Kayacure BP-100 made by Nippon Kayaku
(*h) [4-(methylphenylthio)phenyl]phenylmethane: Kayacure BMS made by Nippon Kayaku
(*i) 2,4-diethylthioxanthone: Kayacure DETX-S made by Nippon Kayaku
(*j) 2-chlorothioxanthone: Kayacure CTX made by Nippon Kayaku
(*k) ethylanthraquinone: Kayacure 2-EAQ made by Nippon Kayaku

It can be seen from Table 5 that some P1 type photopolymerization initiators do not cause yellowing (*c to *f). Curability was inadequate for all 11 types of ink in Table 5.

### Test Example 4

15 types of ink were prepared in the same manner as in Test Example 3, except that the type and added amount of photopolymerization initiator (added amount is in weight parts per 100 weight parts of ink excluding the photopolymerization initiator) were varied as shown in Table 6, two different ink coating film thicknesses were used (5 and 10 μm), and the number of irradiations was changed to 1. The curing state of these inks was rated, and the color of the cured ink was observed. The results are given in Table 6.

TABLE 6

| | Type and added amount (weight parts) | | | | | | Ink coating film 10 μm | | Ink coating film 5 μm | |
|---|---|---|---|---|---|---|---|---|---|---|
| Ink | of photopolymerization initiator | | | | | | | Color after | Curing | Color after |
| No. | (*c) | (*d) | (*e) | (*f) | (*n) | (*o) | Curing state | curing | state | curing |
| 3-1 | 10 | | | | | | A | faint yellow | A | faint yellow |
| 3-2 | 5 | 5 | | | | | A | faint yellow | A | faint yellow |
| 3-3 | 5 | | | 5 | | | A | faint yellow | A | faint yellow |
| 3-4 | 5 | | 5 | | | | A | faint yellow | A | faint yellow |
| 3-5 | | 5 | 2.5 | | | | A | white | B | white |
| 3-6 | | 2.5 | 5 | | | | A | white | B | white |
| 3-7 | | 5 | | 5 | | | A | white | A | white |
| 3-8 | | 5 | 5 | | | | A | white | A | white |
| 3-9 | | 5 | | | | | B | white | C | white |
| 3-10 | | | 5 | 5 | | | A | white | A | white |
| 3-11 | | | | 5 | | | B | white | C | white |
| 3-12 | | | 5 | | | | B | white | C | white |
| 3-13 | 2.5 | | 5 | | | | B | faint yellow | C | faint yellow |
| 3-14 | | | 5 | | 2.5 | | A | faint yellow | B | faint yellow |
| 3-15 | | | 5 | | | 2.5 | C | white | C | white |

(*n) mixture of a bisacylphosphine oxide compound and a benzyl dimethyl ketal compound (Irgacure 1700 made by Ciba Specialty Chemicals)
(*o) benzophenone: BP-100 made by Nippon Kayaku

It can be seen from Table 6 that when a combination of 63 wt % difunctional acrylate monomer and 27 wt % trifunctional acrylate monomer is used as the photoreactive polyfunctional monomer, if an α-hydroxyketone (*d and *e) is used as the photopolymerization initiator in an amount of 5 to 10 weight parts, the cured product is white in color and the curing state is good (inks 3-5, 3-6, 3-8, and 3-9).

It can also be seen that the cured product is white in color and the curing state is good when a combination of an α-hydroxyketone (*d and *e) and benzyl dimethyl ketal (*f) is used as well (inks 3-7 and 3-10).

In contrast, it can be seen that even with a P1 type of photopolymerization initiator, bisacylphosphine oxide (*c) and a blend thereof (*n) are undesirable because coloration tends to occur (inks 3-1 to 3-4 and 3-14).

### INDUSTRIAL APPLICABILITY

The white inkjet ink of the present invention is low enough in viscosity that it will not clog the nozzle of an inkjet printer, and the ink coating film cures well. Further, the white inkjet ink of the present invention does not yellow after curing, exhibiting instead a white color.

1. A white inkjet composed of a photoreactive polyfunctional monomer, a white pigment, and a photopolymerization initiator, wherein the viscosity at 40° C. is 13 mP·s or less, the photoreactive polyfunctional monomer contains a difunctional acrylate monomer or trifunctional acrylate monomer, the total blend amount of the difunctional acrylate monomer and trifunctional acrylate monomer is 50 to 90 wt % of the white inkjet ink, and the weight ratio of the difunctional acrylate monomer to the trifunctional acrylate monomer is from 9/1 to 1/9.

2. The white inkjet ink according to claim 1, wherein the viscosity at 40° C. is 1.0 to 11.5mPa·s.

3. (Canceled)

4. The white inkjet ink according to claim 1, containing 1 to 30 wt % titanium oxide as the white pigment.

5. The white inkjet ink according to claim 1, containing an α-hydroxyketone compound or a benzyl dimethyl ketal compound as the photopolymerization initiator.

6. An inkjet recording method, wherein the white ink according to claim 1 is heated so that its viscosity is 13 mPa·s or less, and printed onto a recording medium by inkjet method.

7. The inkjet recording method according to claim 7, wherein the white ink is heated so that its viscosity is between 1.0 and 11.5 mPa·s.
